(19) United States
(12) Patent Application Publication
(10) Pub. No.: US 2007/0083747 A1
(43) Pub. Date: Apr. 12, 2007

(54) Monitoring device for data processing systems

(76) Inventor: Ingo Buettner, Kerpen (DE)

Correspondence Address: Vincent L Ramik;Diller Ramik & Wight, Suite 101, 7345 Mcwhorter Place, Annandale, VA, 22003, US

(21) Appl. No.: 10/567,335

(22) PCT Filed: Aug. 5, 2004
(86) PCT No.: PCT/EP04/08773

§ 371 Date: Oct. 10, 2006

(30) Foreign Application Priority Data
Aug. 6, 2003 (DE) 103 36 404.8

(51) Int. Cl. G06F 9/00; G06F 12/14; G06F 15/177; H04L 9/32; G06F 11/30

(52) U.S. Cl. 713/2; 713/193

(57) ABSTRACT

The invention relates to a monitoring device (1) for a data processing system (2) in a network with network connections (4) for protecting data memory devices and/or data transmission devices of the data processing system from unauthorized access. Said data processing system comprises a disabling circuit (6) of interfaces (8, 10, 12, 14). According to the invention, only one data memory device (9) is connected to a bootable interface (8) of the data processing system (2) as a mainboot device that can be freely booted; other bootable interfaces (10,12,14) are first disabled; and at least one of the interfaces (10, 12, 14) disabled by means of the disabling circuit (6) is released by means of the network connection (4), from a data processing point (16) located at a distance in the network, after authorization from a person authorised to logon at the data processing point (16).

### BACKGROUND OF THE INVENTION

The invention refers to a monitoring device for a data processing system according to the preamble of claim 1, as well as to a method according to the preamble of claim 25.

Monitoring devices for data processing systems such as computers, for example, are well known. In most cases it is tried to prevent unauthorized accesses to data storage means by authentification requests for the user name and a password.

EP 0 276 450 A1 describes a data protection circuit for disabling the transmission of signals over a bus. In a register, code disable e data are stored as a fixed value and are combined with code key data from a decoder circuit. When the combination yields a certain result, the line of a bus is enabled.

This device is disadvantageous in that the entire circuit is arranged in the data processing system to be protected. Therefore, there is a possibility for skilled users to improperly manipulate the data processing system such that an unauthorized access to the stored media is still possible.

With common software encoding it is also possible to bypass the protection by making a secondary access, e.g. through another operating system, to this software and reading out corresponding code key data.

### SUMMARY OF THE INVENTION

Thus, it is an object of the present invention too provide a monitoring device of the type mentioned above, as well as a monitoring method for a data processing system, wherein the above mentioned disadvantages are overcome and manipulations of the data processing system are impossible or can not be made without being noticed.

The object is achieved with the features of claim 1.

The invention advantageously provides that only a single data storage means is connected to a bootable interface of the data processing system as a main boot device that can be freely booted, that other bootable interfaces are disabled at first and that at least one of the interfaces disabled by the disabling circuit is enabled from a data processing point located at a distance in the network via the network connection after authorization of an authorized person at the data processing point.

In such an arrangement, a data processing system, e.g. a computer, can boot only through a single data storage means, e.g. a hard disc, so that a manipulation of the data processing system, e.g. by installing a new operating system via a bootable interface, is not possible. Bypassing the disabling circuit, e.g. by software, is not possible since the bootable interfaces are disabled through a hardware circuit which can only be enabled by a separate remote data processing point such as a server, for example. An unauthorized access to the bootable interfaces and, accordingly, to the data storage means connected to these interfaces is not possible.

In a preferred embodiment of the invention it is provided that the disabling circuit disables the bootable interfaces via a CMOS. CMOS components are standard components in electronics, they are simple to drive and therefore represent an economic embodiment of the disabling circuit.

According to a development of the invention it is provided that the disabling circuit is integrated on the motherboard. This embodiment is particularly advantageous for new computers to be purchased, since this is an economic variant requiring no further interface such as a card slot, for example.

As an alternative, the disabling circuit may also be arranged on a separate card with a separate interface, preferably a PCI card. An arrangement on a separate card is advantageous since older computers can thus be upgraded in a simple and economic manner.

In a preferred embodiment of the invention, the disabling circuit includes a microcontroller. Using a microcontroller in the disabling circuit makes the same an active circuit that may also be addressed by the software of the data processing system, for example, so that a switching to the disabling state of the disabling circuit can also be effected by a user logging off at the data processing system, for example.

Preferably, the disabling circuit is controlled by the data processing point via a receiving line of the network connection. Thereby, there is no need to use an additional single line of the network connection, i.e. a single wire connection, so that all lines of the network connections can also be used for data transfer.

The disabling circuit may include a reset line. Via this reset line, the disabling circuit can manually be caused to disable, e.g. by combination of keys on the keyboard, or, in the embodiment comprising a power reset, the disabling circuit can be switched to the disabling state by turning off the computer. Further, the above mentioned software control of the microcontroller can be effected via this reset line.

According to a preferred development of the invention, an alarm circuit is provided at least one bootable interface, which alarm circuit is preferably connected to the network connection and is adapted to transmit an alarm signal via the network connection and is preferably connected to a free mass port of the interface. Unnoticed manual manipulation of data storage means connected to the interfaces are impossible due to the alarm circuit. Through the connection to the network connection, the alarm signal can be transmitted via the same and can be registered correspondingly at a remote site. Today, most interfaces have free unused mass ports so that the interface's actual function is not modified by this connection thereto.

In a development of the invention, a housing of the data processing system is provided with an alarm circuit, preferably a key switch, which preferably is connected to the network connection and is adapted to transmit an alarm signal via the network connection. This housing protection prevents unnoticed access to the hardware of the data processing system. Since the alarm circuit is connected to the network connection, an alarm signal can be transmitted to a remote site.

A development of the invention provides that at least one plug-in connection for a keyboard and/or a universal serial port of the data processing system is provided with an alarm circuit, preferably comprising a socket switch, said alarm circuit preferably being connected to the network connection and being adapted to send an alarm signal via the network connection. The arrangement of this alarm circuit prevents an unnoticed access to a universal serial port, e.g. a USB, or, in the case of a plug-in connection of a keyboard, it prevents the interposing of a so-called keyboard recorder that may be used to spy on passwords. By connection to the network connection an alarm signal may be transmitted via the network connection in the event of an unauthorized access, which may be registered at a remote site.

The network connection may be secured against unauthorized access, such as pulling off one or a plurality of pins, by means of an alarm circuit. By this alarm circuit it is registered when manipulations of the data processing system by connecting a new network connection or by connecting one or a plurality of pins of the network connection are attempted.

Preferably, one or a plurality of the alarm circuits are connected to one transmission/reception strand of the network connection, preferably to individual lines. When the alarm circuits are provided at the transmission/reception strand of the network connection, i.e. the part of the connection used for data communication, possible free network connection parts could be used for other purposes in the future. When an alarm is registered, the connection to individual lines allows to associate it to the alarm circuit setting the same off so that it can be registered immediately, for example, whether a hard disc is being removed. Depending on the importance of the perceived manipulation of the data processing system, different alarm programs may be triggered correspondingly.

In a first embodiment of the invention the alarm circuits are mostly connected in parallel und combined in one line. Further, it is provided that the combined alarm circuits are connected to two lines of the network connections via a star wiring and coils, that an alarm detection means is connected via coils to the second line of the network connection, remote from the data processing system, and that an alarm transmission path is established via a phantom line. In this embodiment of the invention little circuit-related effort is required. The transmission path via a phantom line uses only two single lines of the network connections. Providing the coils disables the standard high frequency signal of the network connections from the alarm circuits and the alarm detection means. This is advantageous because a clear signal can be transmitted between the alarm circuit and the alarm detecting means. Providing the resistors at the individual alarm circuits makes it possible, e.g. by varying the size of the resistors, to unambiguously associate the alarm signal, despite the transmission of the alarm signal over only two lines, since the different resistors cause different alarm signals.

In an alternative embodiment of the invention, at least two capacitors are arranged in the individual lines of the network connections, respectively. Between the capacitors, the alarm circuits are connected to the individual lines of the network connection by star wiring. Further, it is preferably provided that the alarm detection means is connected, remote from the data processing system, between the capacitors to the individual lines of the network connection by star wiring, respectively. This configuration is advantageous in that the transmission of an alarm signal can be effected using DC. Separating the individual network connection lines by capacitors allows for an unhindered signal transmission between the alarm circuits and the alarm detection means, which is separated from the rest of the data communication of the network connection without impeding the data communication via the network connection. By arranging the alarm detection means remote from the data processing system, it is possible to detect an alarm without the manipulating person noticing the triggered alarm. Thus, when an alarm is set off, the required measures can be taken to prevent the person from manipulating.

It is provided that an alarm detection is effected by monitoring a rest current applied to the alarm circuits. This allows for an economic solution to the problem of alarm signal transmission and, by the use of differently sized resistors in the alarm circuits, offers the possibility of an exact association of the respective alarm signal even if the number of the interfaces or data storage means to be monitored is greater than the number of the individual lines of the network connections. Moreover, using the rest current allows to make use of the existing data communication paths since these data are transmitted at high frequencies and are not influenced by the rest current.

In a particularly preferred development of the invention, the rest current is generated dynamically by a random-check generator and supplied to the alarm circuits on the one hand and to a parallel reference circuit on the other hand, and is then monitored at a comparator point remote from the data processing system. This is advantageous because in this manner the magnitude of the rest current in the data processing system is unknown and can not be determined, whereby it is impossible to manipulate the alarm circuit by externally applying a rest current of the same magnitude.

In an alternative development of the invention, one or a plurality of the alarm circuits is connected to a separate line strand of the network connection, preferably to respective individual lines. Further, it is provided that an alarm detection means is connected to individual lines of the separate line strand of the network connection, remote from the data processing system. To thus lead the alarm transmission path along a separate line strand of the network connection has the advantage that no mutual interference can occur between the alarm signals and the data communication. Arranging the alarm detection means remote from the data processing system makes a manipulation of the alarm detection means impossible and an alarm can be triggered unnoticed by the person causing the alarm.

In this alternative embodiment, the alarm detection is done by monitoring a rest current applied via the network connections of the alarm circuits.

In a special embodiment with a particularly high security degree, an alarm triggered causes the mechanical destruction of at least one access-protected data carrier of the data processing system through a device, e.g. a bolt gun. This device destroys particularly confidential data in a non-restorable manner so that, when the data processing system is manipulated with high criminal energy, e.g. when the entire data processing system is stolen, these data become useless to the person concerned.

Preferably, a circuit for manually triggering the alarm is provided at at least one of the alarm circuits. This circuit may comprise a manual switch, for example. Thus, an alarm and a resulting disabling of the interfaces and/or a mechanical destruction of a data carrier can also be initiated manually by order of an authorized person.

The invention further refers to a method for monitoring a data processing system in a network with network connections for the protection of data storage and/or data communication means of the data processing system against unauthorized access, wherein upon booting only a single data storage means can be accessed at a bootable interface of the data processing system, other bootable interfaces being disabled at first, and wherein at least one of the interfaces disabled by the disabling circuit is enabled from a data processing point located at a distance in the network via the network connection after authorization of a person authorized to log in at the data processing point.

Here, the data processing point can control the disabling of the interfaces via a receiving line of the network connection and a disabling circuit.

Preferably, after the data processing system and/or a logging off of the user at the data processing system, the disabling of the bootable interfaces returns to a disabled state through a reset.

Removing a data storage means and/or a data transmission means from a data processing system, as well as opening a housing of the data processing system can trigger an alarm at a remote alarm detection means.

The alarm can also be set off manually, e.g. through a switch.

Preferably, a triggered alarm causes the mechanical destruction of at least one access-protected data carrier of the data processing system.

This present method allows to realize the advantages mentioned above.

The following is a detailed description of some embodiments of the invention with reference to the drawings.

### BRIEF DESCRIPTION OF THE DRAWINGS

FIG. 1 is a circuit diagram of the present monitoring device, wherein the transmission path of an alarm signal is established over a phantom line.

FIG. 2 is a circuit diagram of an alternative embodiment of the present monitoring device, wherein the transmission of the alarm signal is effected via individual lines of the network connection.

FIG. 3 illustrates a development of the embodiment of FIG. 2, wherein a circuit for generating a dynamic rest current is additionally connected to the alarm detection.

FIG. 4 is a circuit diagram of another embodiment of the present monitoring device, wherein the transmission path for an alarm signal is formed by separate lines of the network connection.

### DESCRIPTION OF THE PREFERRED EMBODIMENTS

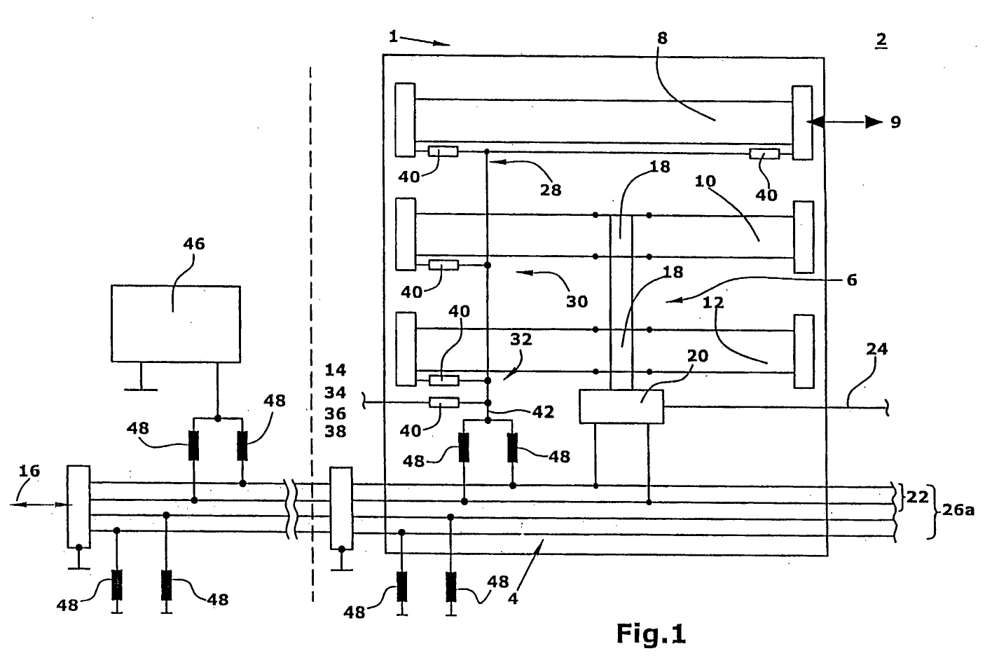

A monitoring device 1 for a data processing system 2 is illustrated as a circuit in FIG. 1. The circuit can be designed as a separate plug-in card or as a circuit provided directly on the motherboard of the data processing system 2.

Only a single data storage means 9, e.g. a hard disc, is connected to a bootable interface 8, e.g. an IDE interface. Other bootable interfaces 10, 12, 14, e.g. a further IDE, a floppy drive, a USB or a firewire interface, respectively have integrated therewith a circuit means 18, e.g. a CMOS, adapted to be disabled. The interface 14 can comprise one or a plurality of interfaces and is not illustrated. In FIG. 1, this is illustrated only for the interfaces 10 and 12. Of course, a circuit means can be integrated similarly in the non-illustrated interface 14. The circuit means 18 are driven by a microcontroller 20. Through the receiving lines 22 of a network connection 4, this microcontroller 20 is connected to a remote data processing point 16, e.g. a central server, not illustrated. Further, a reset line 24 is connected to the microcontroller. The disabling circuit means 18 together with the microcontroller form the disabling circuit 6. Of course, the disabling circuit 6 can also be configured as a passive circuit without a microcontroller. During the booting operation of a computer, the entire disabling circuit 6 is in a disabled state at first. The computer can be booted only from the data storage means 9 connected as the mainboot device. After a person authorized to log in has been authenticated at the data processing point 16 via the network connection 4, the data processing point 16 sends a signal to the microcontroller 20 through the network connection 4 so that the disabling circuit means 18 of the bootable interfaces 10, 12, 14 are enabled and the authorized person has access to all data storage means of the data processing system 2. Of course, it is also possible to enable only individual interfaces 10, 12, 14 so that, depending on the kind of authorization, an authorized person can access a hard disc, for example, but not a CD burner.

The part of the monitoring device described so far is identical in each of the embodiments of the invention illustrated.

In a free port, e.g. a free mass port, of individual or all interfaces 8, 10, 12, 14, alarm circuits 28, 30, 32, 34 are connected. These are combined in one line 42 through parallel-connected resistors 40.

Through further alarm circuits 36, 38, the housing of the data processing system 2 is secured by key switches or, for example the keyboard connection, by socket switches. The socket switches trigger a switching operation in a plug-in wire connection when the wire is pulled off or plugged in. The alarm circuits 36, 38 are also connected through parallel-connected resistors to the line 42 (not illustrated).

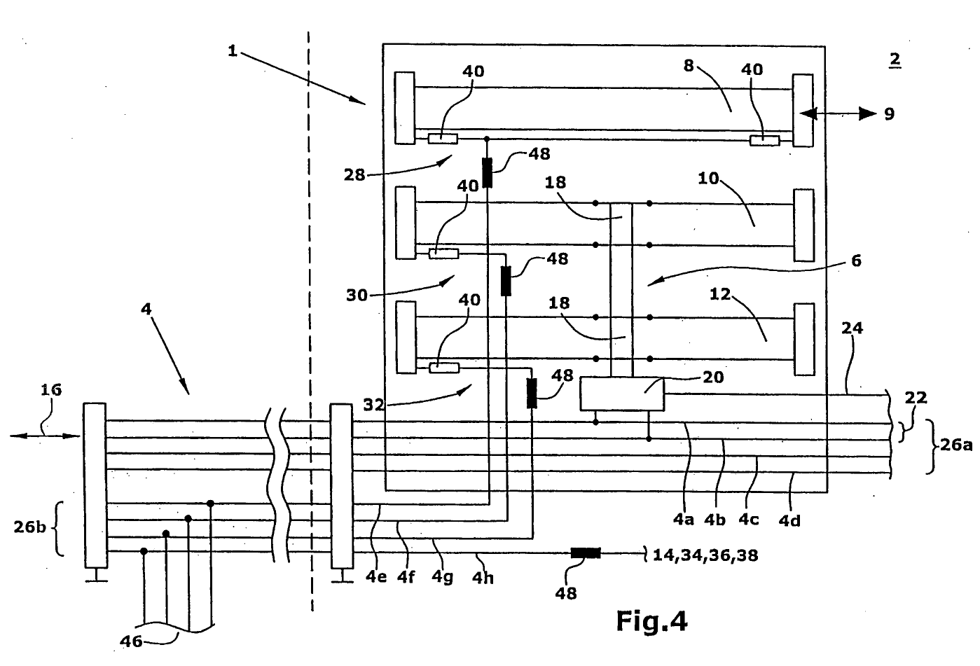

The network connection 4 comprises at least four individual lines which combined form the reception/transmission line strand 26a, wherein two lines being receiving lines 22. Of course, the network connection 4 can also include more lines, as illustrated for example in FIG. 4, having a further separate line strand 26b.

The line 42 is connected to the two receiving lines 22 of the network connection 4 through two coils 48. Remote from the data processing system 2, an alarm detection means 46 is connected to the receiving lines 22 of the network connection 4 through two coils 48. The coils 48 serve to decouple the high frequency signal sent via the network connection 4. The data processing system 46 applies a rest current to the alarm circuits 28-38 through the thus formed phantom line. When one of the alarm circuits is interrupted, e.g. by pulling off an interface, a data storage means or a secured plug-in connection, the rest current will change. This change is registered by the alarm detection means 46 and an alarm is triggered.

The use of different resistors in the alarm circuits 28-38, the alarm detection means 46 can detect the source of the alarm, since the failure of a resistor 40 of a certain magnitude changes the rest current to a certain degree.

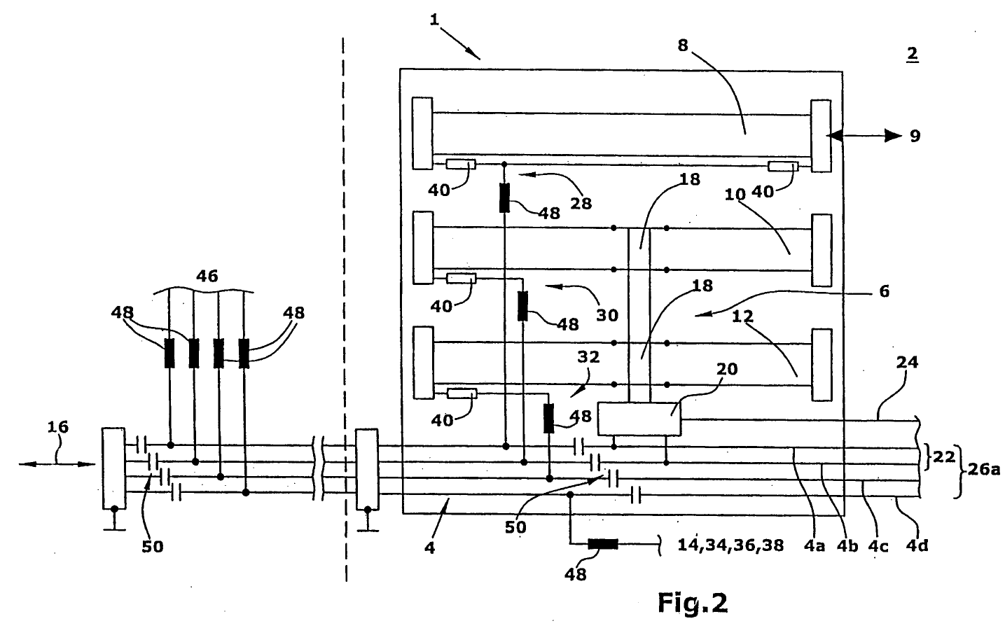

FIG. 2 illustrates an alternative embodiment of the invention. The alarm circuits 28, 30, 32 are each individually connected to a line 4a, 4b, 4c of the network connection 4. The alarm circuits 34, 36, 38, not illustrated in this Figure, are either connected individually to a line 4a-4d of the network connection 4 (not illustrated in this drawing) or they are combined in a line connected to the line 4d of the network connection 4. Each alarm circuit comprises a coil 48 serving as a shield against the high frequency signal of the network connection 4. In each of the alarm circuits 28, 30, 32, 34, 36, 38 a respective resistor 40 is arranged that serves as a ballast in these circuits. By pulling off a hard disc, for example, the corresponding alarm circuit is interrupted. The failure of the resistor causes a change in the rest current.

Remote from the data processing system 2, an alarm detection means 46 is connected to respective individual lines 4a, 4b, 4c, 4d of the network connection 4 through coils 48. Respective pairs of capacitors 50 are arranged such in the individual lines 4a, 4b, 4c, 4d of the network connection 4 that a direct connection path remains between the alarm circuits 28-38 and the alarm detection means 46, this line path being separated from the rest of the network connections 4. The connection lines between the alarm detection means 46 and the network connection 4 may also be combined in one line in an embodiment not illustrated. In this case, it is feasible that the resistors 40 have different magnitudes so that a respective failure of these resistors causes a different change in the rest current, whereby an alarm set off can be associated to a certain alarm circuit. The alarm detection means 46 includes a current source applying a rest current to the alarm circuits 28, 30, 32, 34, 36, 38 via the network connection 4.

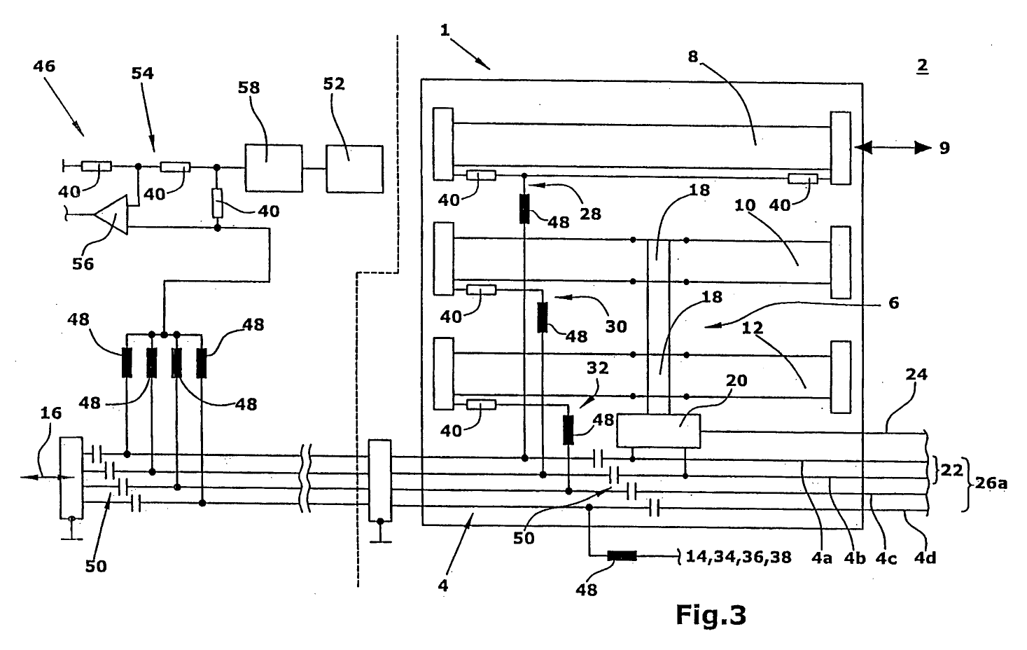

FIG. 3 illustrates a monitoring device of the present invention, wherein the detection of an alarm is effected through a dynamically controlled rest current. The connection lines of the alarm detection means 46 to the network connection 4 include coils 48 for decoupling the high frequency signal in the network connection 4 and are combined in one line. A random-check generator 52 is connected to a power source 58 generating a dynamic rest current and applying the same to the network connection 4 and, therethrough, to the alarm circuits 28, 30, 32, 34, 36, 38. A reference circuit 54 is also connected to the power source. At a comparator point 56, the rest current applied to the reference line 54 and to the alarm circuits is compared. The comparator point 56 registers changes in the dynamic rest current applied to the alarm circuit as compared to the rest current applied to the reference circuit, and triggers a corresponding alarm.

FIG. 4 illustrates another alternative embodiment of the invention. In this embodiment, the alarm signal is transmitted via a separate line strand 26b of the network connection 4. The alarm circuits 28, 30, 32 are connected to individual lines 4e-4g of the network connection 4. The alarm circuits 34, 36, 38 may be connected to the network connection 4 as individual lines 4e-4h (not illustrated) or they can be combined to one line and connected to the individual lines 4h of the network connection 4. Remote from the data processing system 2, an alarm detection means 46 is connected to the individual lines 4e to 4h of the network connection 4. Similar to the previous embodiments, a rest current is applied by the alarm detection means to the alarm circuits 28, 30, 32, 34, 36 via the network connection 4. The individual connection lines of the alarm detection means to the individual lines 4e to 4h of the network connection may also be combined to one line which then connects the same to the alarm detection means 46. The coils 48 illustrated in FIG. 4 are not required if only the alarm signal is transmitted over the separate line strand 26b,

In all embodiments described, only one pole of the rest current is connected to the alarm circuits 28-38. The other pole is formed by ground.

Of course, the invention is not limited to the embodiments illustrated. For example, it is also possible to combine an alarm detection means 46 having a dynamic rest current control, as illustrated in FIG. 3, with a phantom line as the alarm transmission path, as illustrated in FIG. 1. It is further possible to combine different pairs of the alarm circuits 28-38 to individual lines which are then connected correspondingly to the network connection 4. Further components of the data processing system can be secured in a manner similar to that illustrated. Further, the different features of the individual embodiments can of course be combined.

1. A monitoring device (1) for a data processing system (2) in a network comprising network connections (4), for protecting data storage and/or data transmission means of the data processing system against unauthorized access, the data processing system comprising a disabling circuit (6) for interfaces (8, 10, 12, 14),
characterized in
that only a single data storage means (9) is connected to a bootable interface (8) of the data processing system (2) as a mainboot device that can boot freely,
that other bootable interfaces (10, 12, 14) are disabled at first, and
that at least one of the interfaces (10, 12, 14) disabled by the disabling circuit (6) is enabled from a data processing point (16) located at a distance in the network via the network connection (4) after authorization of an authorized person at the data processing point (16).

2. The monitoring device of claim 1, characterized in that the disabling circuit (6) disables the bootable interfaces (10, 12, 14) via a CMOS.

3. The monitoring device of claim 1, characterized in that the disabling circuit (6) is integrated on the motherboard.

4. The monitoring device of claim 1, characterized in that the disabling circuit (6) is arranged on a separate card with a separate interface, preferably a PCI card.

5. The monitoring device of claim 1, characterized in that the disabling circuit (6) includes a microcontroller.

6. The monitoring device of claim 1, characterized in that the disabling circuit (6) is controlled by the data processing point (16) through a receiving line (22) of the network connection (4).

7. The monitoring device of claim 1, characterized in that the disabling circuit (6) comprises a reset line (24), preferably a power reset.

8. The monitoring device of claim 1, characterized in that an alarm circuit (28, 30, 32, 34) is connected to at least one bootable interface (8, 10, 12, 14), said alarm circuit preferably being connected to the network connection (4) and being adapted to transmit an alarm signal via the network connection and, further, preferably being connected to a free mass port of the interface (8, 10, 12, 14).

9. The monitoring device of claim 1, characterized in that a housing of the data processing system (2) is provided with an alarm circuit (36), preferably a key switch, which is preferably connected to the network connection (4) and is adapted to transmit an alarm signal via the network connection (4).

10. The monitoring device of claim 1, characterized in that at least one plug-in connection for a keyboard and/or a universal serial port of the data processing system (2) is provided with an alarm circuit (38), preferably a socket switch, which is preferably connected to the network connection (4) and is adapted to transmit an alarm signal via the network connection (4).

11. The monitoring device of claim 1, characterized in that the network connection (4) is protected against unauthorized access, such as pulling off one or a plurality of terminal pins, for example, by means of an alarm circuit.

12. The monitoring device of claim 8, characterized in that one or a plurality of the alarm circuits (28, 30, 32, 34, 36, 38) is connected to a transmission/receiving line strand (26a) of the network connection (4), preferably to individual lines (4a-d).

13. The monitoring device of claim 12, characterized in that the alarm circuits (28, 30, 32, 34, 36, 38) are connected in parallel through resistors (40) and are combined to one line (42).

14. The monitoring device of claim 13, characterized in that the combined alarm circuits (28, 30, 32, 34, 36, 38) are connected to two lines of the network connection (4) through a star wiring and two coils (44), that an alarm detection means (46) is connected to the two lines of the network connection (4), remote from the data processing system (2), through a star wiring and two coils (48), and that an alarm transmission path is established over a phantom line.

15. The monitoring device of claim 8, characterized in that at least two capacitors (50) are provided in individual lines (4a-d) of the network connection (4), respectively.

16. The monitoring device of claim 15, characterized in that the alarm circuits (28, 30, 32, 34, 36, 38) are connected to the individual lines (4a-d) of the network connection (4) by a star wiring between the capacitors (50).

17. The monitoring device of claim 15, characterized in that an alarm detection means (46) is connected, remote from the data processing system (2), to the individual lines (4a-d) of the network connection (4) by a star wiring between the capacitors (50).

18. The monitoring device of claim 14, characterized in that the alarm detection is effected by monitoring a rest current applied to the alarm circuits (28, 30, 32, 34, 36, 38) via the network connection.

19. The monitoring circuit of claim 18, characterized in that the rest current is generated dynamically by a random-check generator (52), that the rest current is supplied to the alarm circuits (28, 30, 32, 34, 36, 38) on the one hand and to a parallel reference circuit (54) on the other hand, and that the rest currents applied in parallel are monitored at a comparator point (56).

20. The monitoring device of claim 1, characterized in that one or a plurality of the alarm circuits (28, 30, 32, 34, 36, 38) is connected to a separate line strand (26b) of the network connection (4), preferably to individual lines (4e-h), respectively.

21. The monitoring device of claim 20, characterized in that an alarm detection means (46) is connected, remote from the data processing system (2), to the individual lines (4e-h) of the separate line strand (26b) of the network connection (4).

22. The monitoring device of claim 21, characterized in that the alarm detection is effected by monitoring a rest current applied to the alarm circuits (28, 30, 32, 34, 36, 38) via the network connection (4).

23. The monitoring device of claim 8, characterized in that an alarm triggered causes a device, e.g. a bolt gun, to mechanically destroy at least one access-protected data carrier of the data processing system (2).

24. The monitoring device of claim 8, characterized in that a circuit for triggering the alarm manually, e.g. with a manual switch, is provided at at least one of the alarm circuits (28, 30, 32, 34, 36, 38).

25. A method for monitoring a data processing system (2) in a network comprising network connections (4), for protecting data storage and/or data transmission means of the data processing system (2) against unauthorized access,
characterized in
that, upon booting, only a single data storage means can be accessed at a bootable interface (8) of the data processing system (2),
that other bootable interfaces (10, 12, 14) are disabled at first, and
that the disabled interfaces (10, 12, 14) are enabled from a data processing point (16) located at a distance in the network via the network connection (4) after authorization of an authorized person at the data processing point (16).

26. The method of claim 25, characterized in that the disabling of the interfaces (10, 12, 14) is controlled by the data processing point (16) via a receiving line of the network connection (4) and a disabling circuit (6).

27. The method of claim 25, characterized in that the disabling of the bootable interfaces (10, 12, 14) is restored to the disabled state after the data processing system (2) has been switched off and/or after a user has logged off at the data processing system (2).

28. The method of claim 25, characterized in that an alarm is triggered at a remote alarm detection means (46) by removal of a data storage means and/or of a data transmission means of the data processing system (2), as well as by opening a housing of the data processing system (2).

29. The method of claim 28, characterized in that the alarm can be triggered manually, e.g. by means of a switch.

30. The method of claim 28, characterized in that a mechanical destruction of at least one access-protected data carrier of the data processing system (2) is caused by an alarm triggered.

31. The monitoring device of claim 2, characterized in that the disabling circuit (6) is integrated on the motherboard.

32. The monitoring device of claim 2, characterized in that the disabling circuit (6) is arranged on a separate card with a separate interface, preferably a PCI card.

33. The monitoring device of claim 16, characterized in that an alarm detection means (46) is connected, remote from the data processing system (2), to the individual lines (4a-d) of the network connection (4) by a star wiring between the capacitors (50).

34. The monitoring device of claim 17, characterized in that the alarm detection is effected by monitoring a rest current applied to the alarm circuits (28, 30, 32, 34, 36, 38) via the network connection.

35. The method of claim 26, characterized in that the disabling of the bootable interfaces (10, 12, 14) is restored to the disabled state after the data processing system (2) has been switched off and/or after a user has logged off at the data processing system (2).

36. The method of claim 29, characterized in that a mechanical destruction of at least one access-protected data carrier of the data processing system (2) is caused by an alarm triggered.
